(19) United States
(12) Patent Application Publication
(10) Pub. No.: US 2020/0305464 A1
(43) Pub. Date: Oct. 1, 2020

(54) MOIST PET FOOD COMPRISING A PROTEINACEOUS MEAT ANALOGUE HAVING AN IMPROVED TEXTURE

(71) Applicant: TEREOS STARCH & SWEETENERS BELGIUM

(72) Inventors: Andreas REDL, Aalst (BE); Aurelien FENEUIL, Aalst (BE); Fabrice VOGEL, Wolfisheim (FR)

(21) Appl. No.: 16/083,884

(22) PCT Filed: Mar. 8, 2017
(86) PCT No.: PCT/IB2017/051357

§ 371 Date: Sep. 10, 2018

(30) Foreign Application Priority Data
Mar. 9, 2016 (BE) BE2016/5176

(51) Int. Cl. A23K 20/147; A23K 10/30; A23K 20/158; A23K 50/48; A23K 40/10; A23K 20/163; A21D 8/02; A21D 6/00

(52) U.S. Cl. CPC A23K 20/147; A23K 10/30; A23K 20/158; A21D 6/003; A23K 40/10; A23K 20/163; A21D 8/02; A23K 50/48

(57) ABSTRACT

A food composition and more particularly a moist pet food comprising a proteinaceous meat analogue and the method for obtaining such food composition. Also, a food composition for use in improving digestion or improving periodontal health in a companion animal.

This application claims the benefit of Belgian patent application No. 6E2016/5176, filed Mar. 9, 2016, which is hereby incorporated by reference in its entirety.

### FIELD OF THE DISCLOSURE

This disclosure concerns a food composition and more particularly a moist pet food comprising a proteinaceous meat analogue and the method for obtaining such food composition. The disclosure also concerns a food composition for use in improving digestion or improving periodontal health in a companion animal.

### BACKGROUND OF THE INVENTION

Pet food is a specialty food for domesticated animals that is formulated according to their nutritional needs. Pet food generally consists of meat or meat analogues, meat byproducts, cereals, grain, vitamins, and minerals. Within the class of foods known as pet foods, there are three basic subdivisions, dry pet food, semi-moist pet food, and moist pet food. The moisture is determined by considering both the water present in the final product and the water combined with the various components that make up the final product. In general, the dry pet food has a low moisture content which is usually less than about 15% and semi-moist pet food has a moisture content generally ranging from about 15% to about 50%. While there are numerous ways making dry and semi moist pet food, the most commonly used process is extrusion

The moist pet food has a moisture content in excess of more than 50%. The higher moisture content of the moist pet food provides an increased palatability when compared to the dry or semi-moist pet food. Nevertheless, due to the high moisture content of the moist pet food, microbiological stability is a major problem. This problem is overcame only by heat sterilizing and packaging the moist pet food in a hermetically sealed container such as can-like containers, cans, pouches or trays. However, the heat sterilization may reduce the organoleptic characteristics of the moist pet food.

Two types of moist food compositions are generally known in the art. The first is “ground loaf.” Loaf products are typically prepared by contacting a mixture of components under heat to produce an essentially homogeneous, intracellular honeycomb-type mass or “ground loaf.” The ground loaf mass is then packaged into a cylindrical container, such as a can. Upon packing, ground loaf assumes the shape of the container such that the ground loaf must be cut when serving to a companion animal. As a result of processing, ground loaf products exhibit a wide range of textural differences. This kind of product are generally eaten without any mastication. However, mastication or chewing is the first step of digestion, and it increases the surface area of foods to allow more efficient break down by enzymes. Additionally, there is reasonable evidence that soft diets are associated with increased frequency and severity of periodontal disease, and that harder foods requiring vigorous prehension and mastication are preferable for cats and dogs.

Another type of moist food composition is generally known in the art as “chunk and gravy”. Chunk and gravy products comprise pre-formed meat or meat analogue particles, which are mixed with a gravy or sauce. The two components are then filled into a container, usually a can, which is steamed and sterilized. As opposed to the ground loaf, chunk and gravy compositions comprise physically separate, discrete chunks (i.e., pieces of ground meat or meat analogue and grains). These discrete pieces are in the gravy-type liquid in the final container and promote mastication of the animal during absorption. Depending on the process used to obtain these pieces of meat or meat analogue, the texture, the cost and the palatability of the final product will drastically change.

In order to prepare food compositions, and in particular moist pet food compositions that are nutritionally balanced, it is known to blend various types of meat with cereal grains, vitamins, minerals and other micronutrients. Indeed, some meat particles are prepared by making a meat emulsion which is then extruded and formed by physical pressure or thermal energy (for example, by cooking with steam, cooking in water, and oven dry heat). The cooked meat product is diced in meat pieces or is reconstituted in pieces that look like chunks pieces. However, such compositions and notably the pieces used as meat analogue may not have the desired structure, or sufficient firmness, for further processing. Accordingly, such compositions may require additional treatments. Moreover, if the firmness of the piece is not sufficient, neither adequate comminution nor sufficient resident time of the food takes place in the mouth of the pet, so that digestion is transferred to the gastrointestinal tract.

In order to improve structure and firmness of the meat analogue other products have been developed among which texturized meat analogues. Such products obtained by an extrusion step at high temperature (more than 120° C.) are usually named high moisture texturized proteins (HMTP) or low moisture texturized proteins (LMTP). The methods for obtaining LMTP are for example disclosed in U.S. Pat. No. 5,922,392, GB1288193, U.S. Pat. No. 3,769,029 or WO2012/008994 and provide products having spongy texture and which cannot be shaped easily without using binders such as eggs. The HMTP are difficult to manufacture and may have a mushy consistency if expansion directly after the extrusion at high temperature. Usually, a cooling die is used at the end of the extrusion in order to avoid any expansion of the product. However, such cooling die is regularly clogged, thereby varying pressure within the barrel of the extruder and resulting in an unpredictable efflux of the product from the die as mentioned in US 20100136201. Moreover, an incorrect orientation of fibers in the product may take place inducing additional treatment of the product to re-orientate the fibers. Such treatment leads to complex and costly installations. This process being very sensitive, it can be implemented with a limited panel of ingredients (limited flexibility in the formulations) as mentioned in the International Patent Application WO03007729. Consequently such costly products are not recommended for animal nutrition. Indeed, a simple and cheap process providing a proteinaceous meat analogue having a good texture is needed. Additionally, HMTP as mentioned in US 2006105098 has a limited shelf-stability.

Other meat analogues described in prior art may be obtained by agglomerating protein filaments or protein fibers by using a binder such as albumin notably by making an emulsion then coagulating the emulsion obtained, such process is disclosed in GB977238. Such protein filaments or protein fibers are obtained by spinning process, which consists in the precipitation of a protein solution to form stretched fibers. However, spinning produces large waste water streams. In addition, the necessity for low pH, high salt concentrations and chemical additives makes the process very complex to implement (Manski et al., 2007).

Consequently, there is a need for a food composition dedicated to animals comprising pieces of proteinaceous meat analogue showing improved meat-like properties with regard to texture, chewiness and bite, compared to already existing products and having sufficient structure and firmness to resist to all the processing needed to guaranty microbiological stability and palatability of the product obtained. Further, it would therefore be desirable to provide improved methods of preparing food compositions with a desirable palatability, structure and firmness.

### DETAILED DESCRIPTION OF EMBODIMENTS OF THE INVENTION

A food composition comprising a proteinaceous meat analogue and the method for obtaining such food composition

Some embodiments of the invention concern a food composition comprising at least a first component and a second component in contact with (e.g. immersed in) the first component, wherein said first component is substantially water-based and is preferably a liquid, pasty or gelled component such as sauce, gel, gravy, juice and the like, and wherein the second component is a solid component comprising a proteinaceous meat analogue

wherein, said proteinaceous meat analogue comprises:
more than 50% (w/w), preferably, between 60 to 70% (w/w), preferably between 62 to 68% (w/w), more preferably more than 65% (w/w) water content
15-25% (w/w), preferably 17 -20% (w/w) proteins such as vegetable proteins, preferably, vegetable proteins among which more than 60% wheat gluten (preferably more than 70%, more preferably between 75 and 80%, or typically 100% of wheat gluten)
optionally, 2-8% (w/w) fat, preferably 2-5% (w/w) , preferably, between 3 to 4% (w/w)
8-15% (w/w) carbohydrates, typically between, 10 to 12% (w/w) preferably of which less than 4% (w/w) of plasticizer, preferably 1 to 3.5% (w/w), more preferably 1.5 to 3% (w/w),
2 to 8% (w/w) fibers, typically, between 3 to 6% (w/w), more preferable 3.1 to 5.8% (w/w), and/or

wherein said proteinaceous meat analogue has a torque value at 10 mn of at least 6 gram meter (preferably between 6 to 20, more preferably between 8 to 15) and/or a ratio torque value at 30 sec/torque value at 10 mn of about 1 to 1.7, as determined by a Test A wherein test A is implemented by introducing a 70 g cube of an hydrated sample to be tested in a mixing chamber thermo-stated at 37° C. of a Brabender Plastograph, type EC equipped with a type 50 measuring head and a mixing chamber comprising two counter-rotating identical sigma shaped mixing blades, measurement is obtained by counter-rotating the mixing blades at differential speeds of 34 rpm and 22.67 rpm (34*2/3).

The invention in some embodiments also concerns a food composition comprising at least a first component and a second component in contact with (eg immersed in) the first component, wherein said first component is substantially water-based and is preferably a liquid, pasty or gelled component such as sauce, gel, gravy, juice and the like, and wherein the second component is a solid component comprising a proteinaceous meat analogue

wherein, said proteinaceous meat analogue comprises:
more than 50% (w/w), preferably, between 60 to 70% (w/w), preferably between 62 to 68% (w/w), more preferably more than 65% (w/w) water content
15-25% (w/w), preferably 17-20% (w/w) proteins such as vegetable proteins, preferably, vegetable proteins among which more than 60% wheat gluten (preferably more than 70%, more preferably between 75 and 80%, or typically 100% of wheat gluten) and/or

wherein said proteinaceous meat analogue has a torque value at 10 mn of at least 6 gram meter (preferably between 6 to 20, more preferably between 8 to 15) and/or a ratio torque value at 30 sec/torque value at 10 mn of about 1 to 1.7, as determined by a Test A.

The invention in some embodiments concerns a food composition comprising at least a first component and a second component in contact with (e.g. immersed in) the first component, wherein said first component is substantially water-based and is preferably a liquid, pasty or gelled component such as sauce, gel, gravy, juice and the like, and wherein the second component is a solid component comprising a proteinaceaous meat analogue, said proteinaceous meat analogue comprises vegetable proteins among which at least wheat gluten, optionally a carbohydrate and/or fibers and said proteinaceous meat analogue has a water content of between 60 to 70%, more preferably 62 to 68%, even more preferably 65% water content, a torque value at 10 mn of at least 6.5 gram meter (preferably between 7 to 20, more preferably between 8 to 15, even more preferably between 10 and 12) or a ratio torque value at 30 sec/torque value at 10 mn of about 1 to 1.5, as determined by a Test A.

Preferably, the proteinaceous meat analogue has a ratio torque value at 30 sec/torque value at 10 mn of about 1 to 1.5, preferably 1 to 1.4, more preferably 1 to 1.3, of about 1.1 to 1.25.

Indeed, an aim of embodiments of the invention is to provide food composition comprising a meat analogue which may be a good meat replacer. The inventors have shown that the characteristic which is important to be a good meat analogue is to give the feeling of meat during mastication. The inventors have shown that to the opposite of the meat analogues of the market such as for example, the low moisture texturized proteins, the meat analogue of embodiments of the invention gives a feeling which is very close to meat due to its physicochemical characteristics. The feeling during the first bite (30 sec) than after several mastications (10 min) can be evaluated by the ratio torque value at 30 sec/torque value at 10 min.

As used herein the “torque value at 30 sec” is the value measured in the first 30 sec of the Brabender Plastograph assay (Test A). As used herein the “torque value at 10 mn” is the value measured after 10 min of the Brabender Plastograph assay. The torque values are measured in gram meter (g*m).

As used herein the torque value at 30 sec and the torque value at 10 mn of the proteinaceous meat analogue are evaluated according to a Test A by using a Brabender Plastograph, type EC equipped with a type 50 measuring head and a mixing chamber comprising two counter-rotating identical sigma shaped mixing blades (references of the blades: Sigma (S)), 70 g of cube shaped samples (15*15 mm) are introduced in a mixing chamber thermo-stated at 37° C. and measurement is obtained by counter-rotating the mixing blades at differential speeds of 34 rpm and 22.67 rpm (34*2/3). If needed, the samples may be washed before analysis in order to remove any residual sauce, for example by several washing steps with water and if needed hot water.

According to some embodiments of the invention, said proteinaceous meat analogue is a cohesive material. Typically, said proteinaceous meat analogue has a Fi value of more than 30%, preferably between 50% and 80%.

As used herein, the “Fi value” refers to the percentage of protein insoluble in a SDS buffer. The Fi value reflects the level of crosslinking of the gluten proteins. Indeed, it has been demonstrated that a Fi value of vital gluten is less than 10% (Redl A, Morel M H, Bonicel J, Guilbert S, Vergnes B. Rheol Acta 1999; 38(4):311-20). A Fi value of more than 30% is observed for example when the gluten has undergone a thermal treatment.

The Fi value may be measured according to a method well known from the man skilled in the art, and is described for example in Redl A, Morel M H, Bonicel J, Guilbert S, Vergnes B. Rheol Acta 1999; 38(4):311-20. The Fi value of the proteinaceaous meat analogue is provided by the static heating step of the method of some embodiments of the invention.

As used herein, the term “fat” refers to vegetal or animal lipids. Typically, fat may be triacylglycerides or triglycerides formed by the esterification reaction of long chain-, medium chain- or short chain-fatty acids with glycerol, a trihydroxy alcohol, or a mixture thereof, in any of solid, liquid or suspension forms, regardless of whether they are obtained from animal, fowl, fish or plants sources or are made synthetically, so long as they are safe for consumption by animals for which it is destined (eg. companion animals, humans . . . ).

As used herein, “Carbohydrate” refers to at least a source of carbohydrates such as, but not limited to, monosaccharides, disaccharides, oligosaccharides, polysaccharides or derivatives thereof. Typically the carbohydrate is a plasticizer.

As used herein “food composition” means a product or composition that is intended for ingestion by an animal. In one embodiment, the food compositions are formulated to provide “complete and balanced” nutrition for an animal, preferably a companion animal, according to standards established by the Association of American Feed Control Officials (AAFCO). In another embodiment, the food composition is a pet food composition. Typically the food composition comprises the recommended concentrations of fat, proteins and carbohydrates for a companion animal.

The term “animal” means any animal that could benefit from or enjoy the consumption of food compositions of the present invention, including human, avian, bovine, canine, equine, feline, hircine, lupine, murine, piscine, ovine, or porcine animals. In various embodiments, the animal is a companion animal, the term “companion animal” means domesticated animals such as cats, dogs, rabbits, guinea pigs, ferrets, hamsters, mice, gerbils, horses, cows, goats, sheep, donkeys, pigs, and the like.

The term “meat” means edible flesh of animals including avian, piscine, bovine, equine, ovine, or porcine animals. Meat includes muscle tissue, mechanically deboned tissue, organs, or combinations thereof.

Whether alone or blended, the food compositions can be coated with fats and other palatability enhancers, e.g. animal digest.

Typically, said second solid component has a mass of at least one gram preferably 2 to 300 g, more preferably 3 to 30 g typically 5 to 20 g. Advantageously, said second solid component has a cubic or a circular shape

According to some embodiments of the invention, said first component is a substantially water-based, the term “substantially water based” means that said first component comprises at least 70% of water, typically at least 80%, preferably between 82 and 99%, more preferably 83 to 98%, even more preferably between 85 and 95% of water.

Said first component is typically liquid, pasty or gelled. Indeed, it has a fluid characteristic and may supplies aroma, palatability, and some additional nutritional properties such as additional vitamins, minerals, and the like. Said first component may comprise food particles notably vegetables particles such as for example particles of nuts, cereals, carrots and/or leguminous.

Typically, said first component comprises at least 70% (w/w) of water, 0.1 to 5% (w/w) thickeners preferably, gum and/or starch, 0.1 to 1% (w/w) of coloring agent, 0.1 to 1% (w/w) of flavor, 0.01 to 3% (w/w) salt, 0.01 to 3% (w/w) emulsifiers. Typically the gums may be cassia gum, guar gum, carob gum, carrageenan and a mix thereof. The starches may be native and/or modified starches.

The invention in some embodiments further concerns a method for obtaining a food composition comprising at least a first component and a second component in contact with the first component, wherein said first component is a substantially water-based, preferably a liquid, pasty or gelled component, and wherein the second component is a solid component comprising a proteinaceaous meat analogue, said method comprises a step of:
a) obtaining said proteinaceaous meat analogue by:
   mixing at a temperature of less than 100° C. i) vegetable proteins among which at least vital wheat gluten (VWG) ii) a plasticizer preferably, said plasticizer is selected among a polyhydroxy alcohol, a starch hydrolysate, a carboxylic acid and mixture thereof and optionally iii) fibers for obtaining a dough,
   optionally shaping said dough, preferably by cutting, sheeting, agglomerating and/or molding typically by at least cutting the dough in dough pieces and agglomerating said dough pieces to obtain an agglomerate, preferably, agglomerating said dough pieces with at least one inclusion to obtain said agglomerate, and
   heating preferably static heating between 120 to 160° C. during 1 minute to 1 hour of said dough or said agglomerate for obtaining said proteinaceous meat analogue,
b) optionally incorporating said proteinaceous meat analogue with food particles to obtain a solid mix comprising said proteinaceous meat analogue
c) incorporating said proteinaceous meat analogue or a solid mix comprising said proteinaceous meat analogue in said first component and obtaining said food composition
d) optionally thermally processing said food composition

According to some embodiments of the invention, the thermally processing step is implemented at a temperature of more than 100° C., typically, at a temperature between 30 to 200° C. during 1 minute to 1 hour. Said thermally processing may be a cooking step such as for example a sterilization step.

The invention in some embodiments further concerns a food composition comprising said proteinaceous meat analogue directly obtained by a method of an embodiment of the invention.

Advantageously the mixing step is implemented by mixing i) 30 to 90%, preferably 40 to 85% (w/w) of VWG powder, ii) 10 to 40% (w/w) of a plasticizer, iii) 0 to 40% (w/w) preferably 3 to 30% (w/w), typically 5 to 20% of a vegetable protein other than VWG and iv) 0 to 8% (w/w), preferably, 1 to 5% (w/w) of fibers.

Typically, the mixing step may be implemented by any mixing device capable of handling high viscosity materials (such as Z blenders, ribbon mixers, planetary mixers or co rotating intermeshing extruders). Advantageously, the mixing step is carried out in a batch or a continuous mixing unit, preferably at a temperature of less than 100° C. (such as between 20 to 90° C., preferably, 30 to 65° C. more preferably 40 to 50° C.) for a period sufficient to obtain a dough-like composition. Typically, the mixing step is an extrusion step.

According to the invention, an “extrusion” refers to a process in which a material is pushed under compressive stresses through a deformation control element such as a die to form an elongated product. Continuous extrusion refers to an extrusion process where such deformation is carried out on a product of unlimited length. Advantageously, the extrusion according to some embodiments of the invention is implemented at a temperature of less than 100° C., such as between 20 to 90° C., preferably, 30 to 65° C. more preferably 40 to 50° C. Indeed, the inventors have shown that a mixing step at a temperature above 100° C. notably by extrusion at temperature above 100° C. provides a product having spongy texture which is not observed for the product of embodiments of the invention.

Advantageously, a food product, a food additive and/or a processed food may be added during the mixing step. Such food product, food additive and/or processed food may be in a dried form or a hydrated form, typically by having a water content of more than 50%.

As used herein “processed food” refers to a food which is significantly modified from its natural state, as by mechanical alteration (such as grinding or chopping), combination with other food products or additives, and/or cooking. As used herein, “processed food” excludes foods which substantially maintain their natural state after processing. For example, fresh product may be washed, sorted, coated or treated, and packaged, but remain substantially in its natural state after processing, and would not be considered a “processed food” for the purpose of this disclosure. A “processed food” also refers to an extract of food. The “extract” refers to the resultant solid or liquid material from an extraction. Indeed, an extract obtained from animal origins (such as meat or fish) or vegetal origins, such extract may be soluble or insoluble carbohydrates, proteins, fibers, fat, or combinations thereof. The processed food may comprise oil or fat particles, and particularly preferred is vegetable oil or fat, especially that used in the form of sunflower oil. The processed food may also comprise particles of an inorganic salt. Calcium or magnesium salts are preferred. The processed food may comprise an insoluble material, for example an insoluble organic or inorganic salt.

As used herein “food products” refers to pieces of meat or fish or vegetables such as for example nuts, cereals, carrots, leguminous.

As used herein “food additives” preferably includes simulated meat flavorings such as pork flavor, pepperoni flavor, smoke powder, chicken flavor, beef flavor, seafood flavor, savory flavorings (e.g., onion, garlic), minerals (such as KCl, Copper sulfate (CuSO4) . . . ), amino acids (lysine, isoleucine . . . ) vitamins (such as vitamins B12, vitamin E, vitamin A) and mixtures thereof.

As used herein “food particles” refers to a coherent mass which is a food product, a food additive and/or a processed food.

According to some embodiments of the invention, said dough obtained by mixing of vegetable proteins and at least one plasticizer can further be shaped before the static heating.

The shaping step according to the invention in some embodiments comprises at least one or a combination of cutting, molding, sheeting and agglomerating steps. Preferably, the shaping step comprises at least a cutting step and a molding or a sheeting step, more preferably a cutting step, a sheeting step and a molding step.

According to one embodiment, the shaping step comprises a cutting step, an agglomerating step and optionally a molding and/or a sheeting step.

The cutting step may be done by using any means having at least one blade, for example a meat mincer (mincing machine), or a meat cutter.

Typically, the shaping step comprises a cutting step, an agglomerating step and optionally a molding and/or a sheeting step.

Advantageously, the agglomeration is carried out by i) hydrating the dough pieces and/or said at least one inclusion and ii) mixing to obtain an agglomerate, typically having a water content of between 5%-30%, preferably 7-25%, more preferably 10-20%.

According to one embodiment, the agglomeration may be carried out by
i) hydrating the dough pieces, preferably by spraying 1-10% water by weight of dough pieces, ii) adding the at least one inclusion, and iii) mixing to obtain an agglomerated mixture typically having a water content of between 5%-30% (w/w), preferably 7-25% (w/w), more preferably 10-20% or
i) hydrating the mixture of dough pieces and the at least one inclusion, preferably by spraying 1-10% (w/w) water by weight of dough pieces, and ii) mixing the hydrated mixture to obtained an agglomerated mixture typically having a water content of between 5%-30% (w/w), preferably 7-25% (w/w), more preferably 10-20% (w/w) or
i) hydrating at least one inclusion preferably by spraying 1-10% (w/w) water by weight of dough pieces, ii) adding the dough pieces, and iii) mixing to obtain an agglomerated mixture typically having a water content of between 5%-30%, preferably 7-25% (w/w), more preferably 10-20% (w/w).

As used herein, the term “inclusion” refers to a coherent mass which is a food product a food additive and/or a processed food. The inclusion is not a dough piece according to the invention. The inclusion should be of a size that is visible, as a discrete piece or pieces, in the meat analogue prepared. Preferably the inclusion has a maximum linear dimension of at least 1 mm, preferably of at least 3 mm, preferably between 1 and 8 mm. Unless stated otherwise, the size of the inclusion is quoted as the maximum linear dimension of the inclusion, i.e. the maximum length in any dimension. Typically, the inclusion may be a dried or an hydrated product or may contained naturally water.

According to some embodiments of the invention, the dough piece has a mass of at least 0.03 g preferably 0.04 to 300 g more preferably 0.05 to 30 g, 0.05 g to 3 g typically 0.05 g to 0.2 g. Advantageously, said dough piece may have a long or a circular shape.

The sheeting step may be implemented by compressing dough pieces between cylindrical rolls

The molding step may be implemented by compressing dough pieces into molds of any desired shape.

The method of embodiments of the invention is particularly advantageous in that without any added binder, the product develops a very good agglomerating and molding properties providing big pieces of meat analogues having very high volume. Moreover, the texture of the product obtained is dense enough to provide a uniform piece of meat analogue. Such pieces cannot be obtained by using the meat analogues of the prior art without adding a binder such as eggs or xanthan or starch providing a product having poor texture.

Moreover, the meat analogue according to embodiments of the invention is particularly easy to mold and provides structure having irregular forms close to natural meat steaks or beefsteaks. Besides, the shaping steps such as the cutting, agglomerating, sheeting and molding steps can be repeated in order to obtain a product having a fibrillar structure which can be close to the myofril structure of skeletal muscles. Typically, a very nice fibrillar structure can be obtained when the dough pieces are of longitudinal shape.

As used herein the term “static heating” refers to a heating step without any stirring or shearing of the dough to be heated. An example of static heating may be oil frying, microwaving, or by using an oven, or a hot plate. Typically, the heating step is carried out at a temperature between 120 to 160° C. during 1 minute to 1 hour, typically, 10 min to 30 mn. The duration of the heating step can be adapted by the man skilled in the art depending on the volume of mixed proteins to be heated. The inventors have shown that boiling (100° C.) or heating at 110° C. of the mix of vegetable proteins and plasticizer does not provide the meat analogue of embodiments of the invention. Moreover, an heating step above 160° C. for example a classical frying step (at 185° C.) provides a product which has a very soft and spongy texture and a dark color.

It should be emphasized that meat analogues in accordance with embodiments of the present invention may be used as meat replacements to provide a meatless foodstuff or as meat enhancers/extenders to replace a portion of the meat that would normally be present in a foodstuff.

Preferably, the vegetable proteins are powdered vegetable proteins (as measured according to AOAC 979.09; Kjeldahl method with a conversion factor N*6,25). Advantageously, said vegetable protein powder has a water content of between 1 to 15% (w/w) preferably 2 to 12% (w/w), typically, 3 to 7% (w/w). Said vegetable proteins may be vital wheat gluten (100% of vital wheat gluten) advantageously a vital wheat gluten powder. Typically, said vegetable proteins are a mixture of vital wheat gluten and vegetable proteins from at least one other origin. According to one embodiment, vegetable proteins comprise more than 50% of vital wheat gluten, preferably, more then 60, 70, 80, 85, 95% of vital wheat gluten. Preferably, the “vegetable proteins from at least one other origin” or “vegetable protein other than wheat gluten” may be selected from a group consisting of potato, lupine, soya, pea, chick pea plants, alfalfa, faba bean, lentil, bean, rapeseed, sunflower and cereals such as corn, barley, malt and oats. Said vegetable proteins are typically in the form of flour, concentrate or isolate. Advantageously, the vegetable protein other than wheat gluten is selected from a group consisting of potato, cereals, lupine, soya, pea chick pea proteins and a mix thereof. Preferably the ratio vegetable protein other than wheat gluten/wheat gluten is between 0/100 and 60/40, preferably 1/99 to 40/60, more preferably 2/98 to 30/70.

As used herein the term “vital wheat gluten” refers to those forms of dried wheat gluten that have been subjected to only minimal or no heat denaturation during drying. Upon reconstitution with water, vital wheat gluten shows physical properties (e.g., elasticity, gumminess, etc.) similar to those of freshly prepared wet wheat gluten.

“Vital wheat gluten” or VWG also refers to the dried, insoluble gluten portion of wheat flour from which the starch and soluble components have been removed by a washing process. Typically, vital wheat gluten is then dried to a fine powdered state. Vital wheat gluten powder typically has a percent protein on a dry basis of about 80% or greater (as measured according to AOAC 979.09; Kjeldahl method with a conversion factor N*6,25). Vital wheat gluten is typically not denatured as determined by the test procedure in “Approved Methods of the American Association of Cereal Chemist”, Method 38 entitled “Vital Wheat Gluten” (December 1962). Useful vital wheat gluten powder is commercially available under the trade designation AMYGLUTEN®.

As used herein, a “plasticizer” refers to a compound that increases the plasticity or fluidity of the material to which it is added. Typically, the plasticizer of some embodiments of the invention is a “food grade plasticizer” which is a plasticizer approved to be used in foods. Advantageously, the plasticizer is a non-aqueous plasticizer, typically said plasticizer has a water content of less than 20% (w/w). Advantageously the plasticizer may be a polyhydroxy alcohol (such as glycerol, sorbitol, ethylene glycol, polyethylene glycol propyleneglycol, butanediol, polyethylenglycol and mixture thereof), a starch hydrolysate (such as a glucose syrup), a carboxylic acid and mixture thereof.

As used herein, “fibers” may be insoluble fibers, preferably from cereal, tuber, seed or leguminosae.

The term “water content” refers to the content of water based upon the Loss on Drying method as described in Pharmacopeial Forum, Vol. 24, No. 1, page 5438 (January-Feburary 1998). The calculation of water content is based upon the percent of weight that is lost by drying.

Use of the Food Composition in Improving Digestion or Improving Periodontal Health

The invention in some embodiments also concerns a food composition according to an embodiment of the invention for use in improving digestion or improving periodontal health in a companion animal.

Indeed, the improved texture of the solid component of the food composition according to some embodiments of the invention provided by the meat analogue is very healthy.

Firstly, due to its improved texture, the invention in embodiments provides an increase of mastication and thus there will be an improvement of comminution of the food in the mouth of the pet but also an increase of resident time in the mouth and a better salivation, those events leading to a better digestion.

Moreover, hygiene will be improved because the mouth is better cleaned with respect to bacteria due to the salivation. Finally, the dental plaque will be reduced due to improved texture so more chewing. As well, circulation of blood in gingiva will be improved due to more chewing.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a food analog” or “a method” includes a plurality of such “food analogs” or “methods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context.

The terms “comprising” or “including” are intended to include embodiments encompassed by the terms “consisting essentially of” and “consisting of”. Similarly, the term “consisting essentially of” is intended to include embodiments encompassed by the term “consisting of”. Although having distinct meanings, the terms “comprising”, “having”, “containing” and “consisting of” may be replaced with one another throughout the above description of the invention.

All percentages expressed herein are by total weight of the composition unless specifically stated otherwise. The skilled artisan will appreciate that the term “dry matter basis” means that an ingredient's concentration in a composition is measured after any free moisture in the composition is removed.

“About” means a referenced numeric indication plus or minus 10% of that referenced numeric indication. For example, the term about 4 would include a range of 3.6 to 4.4. All numbers expressing quantities of ingredients, reaction conditions, and so forth used in the specification are to be understood as being modified in all instances by the term “about.” Accordingly, unless indicated to the contrary, the numerical parameters set forth herein are approximations that can vary depending upon the desired properties sought to be obtained. At the very least, and not as an attempt to limit the application of the doctrine of equivalents to the scope of any claims, each numerical parameter should be construed in light of the number of significant digits and ordinary rounding approaches.

Wherever the phrase “for example,” “such as,” “including” and the like are used herein, the phrase “and without limitation” is understood to follow unless explicitly stated otherwise. Therefore, “for example vital wheat gluten” means “for example and without limitation vital wheat gluten.”

“Typically” or “optionally” means that the subsequently described event or circumstance may or may not occur, and that the description includes instances where said event or circumstance occurs and instances where it does not. For example, the phrase “the meat analogue can optionally contain vitamin B12” means that the meat analogue may or may not contain vitamin B12 as an ingredient and that the description includes both meat analogue containing vitamin B12 and meat analogue not containing vitamin B12.

The invention will be further evaluated in view of the following examples and figures.

### EXAMPLES

### Example 1: Preparation of Wheat Gluten Based Intermediates

Vital wheat gluten powder (AMYTEX®) (63 parts), glycerol (100%) (33 parts) and wheat fiber (VITACEL® WF400 or VITACEL® WF200) (4 parts) were continuously mixed together in a twin screw extruder (Werner & Pfleiderer ZSK25) at a temperature of 65° C., and shaped and cut to obtain small particles. These particles can then be stored at room temperature, without risk of spoilage.

Another recipe comprising vital wheat gluten powder (AMYTEX®)(50 parts), glycerol (100%)(33 parts), chick pea flour (13 parts) and wheat fiber (VITACEL® WF200) (4 parts) was also processed the same way. Three different kinds of products (A1, A2, and A3) were obtained, consisting of WF400 (A1), of WF200 without chick pea flour (A2) and of WF200 with chick pea flour (A3).

Agglomerates of these particles were prepared by spraying 11 parts of water over the particles, and manually pressing the hydrated particles together into a mould of 15 mm thickness. The agglomerates obtained were then fried in cooking oil at 150° C. for 10 minutes, thereby providing products P1, P2 and P3.

P1 is coming from A1. P2 is coming from A2. P3 is coming from A3.

### Example 2: Chewing and Bite Properties of these Agglomerates

The torque values of these 3 products (P1, P2 and P3) were compared with pet food products from the market: treats (PEDIGREE® DENTASTIX® and DENTAL PROBAR®), semi-moist pet food products (FIDO® TENDRES BOUCHÉES and FROLIC® COMPLET), pet food products with a dual texture (FROLIC® CROQUI MOELLEUX and PROPLAN DUO) and dry pet food products (ROYAL CANING HYPOALLERGENIC DR21). In the following table, torque values are given after 30 seconds, 10 minutes and 14 minutes for all the above cited products.

TABLE 1

| | | Torque at | Torque at | Torque at | Torque 30 |
|---|---|---|---|---|---|
| Pet food | Name of | 30 sec | 10 min | 14 min | sec/Torque |
| category | product | (in g*m) | (in g*m) | (in g*m) | 10 min |
| Treat | PEDIGREE ® | 384 | 50 | 63 | 7.7 |
| | DENTASTIX ® | | | | |
| | DENTAL | 139 | 17 | 12 | 8.2 |
| | PROBAR | | | | |
| Semi-moist | FIDO ® | 93 | 9 | 6 | 10.2 |
| | TENDRES | | | | |
| | BOUCHÉES | | | | |
| | FROLIC ® | 36 | 4 | 3 | 8.8 |
| | COMPLET | | | | |
| Dual | PROPLAN | 37 | 14 | 11 | 2.7 |
| texture | DUO | | | | |
| | FROLIC ® | 50 | 10 | 7 | 5.2 |
| | CROQUI | | | | |
| | MOELLEUX | | | | |
| Dry | ROYAL CANIN ® | 33 | 7 | 5 | 5.1 |
| | HYPOALLERGENIC | | | | |
| | DR21 | | | | |
| Product of | P1 | 174 | 21 | 23 | 8.4 |
| the | P2 | 145 | 39 | 22 | 3.7 |
| invention | P3 | 171 | 33 | 19 | 5.2 |

### Example 3

Products P1, P2 and P3 were also hydrated for 48 hours in water, drained, put in boiling water until water boils again, removed from boiling water, drained through a sieve, washed with cold water (thereby providing products W1, W2 and W3 respectively) and then compared with pet food products from the market in term of torque.

Pet food products from the market were the same as in example 2 except that before analysis they were hydrated for 48 hours in water, drained, put in boiling water until water boils again, removed from boiling water, drained through a sieve, washed with cold water.

The only pet food product that withstands hydration is PEDIGREE® DENTASTIX®. The other pet food products of this example were not able to be drained before putting in boiling water because they were forming a whole mass with water used for hydration.

In the following table, torque values are given after 30 seconds, 10 minutes and 14 minutes for all the above cited products.

TABLE 2

| | | Torque at | Torque at | Torque at | Torque 30 |
|---|---|---|---|---|---|
| Pet food | Name of | 30 sec | 10 min | 14 min | sec/Torque |
| category | product | (in g*m) | (in g*m) | (in g*m) | 10 min |
| Product of | W1 | 18 | 12 | 12 | 1.5 |
| invention | W2 | 14 | 12 | 11 | 1.2 |
| | W3 | 16 | 10 | 10 | 1.5 |
| Hydrated | PEDIGREE ® | 14 | 15 | 16 | 1.0 |
| treat | DENTASTIX ® | | | | |
| | (after | | | | |
| | preparation | | | | |
| | steps | | | | |
| | described in | | | | |
| | example 3) | | | | |

### Example 4

Products W1, W2 and W3 were then compared with other pet food products and more particularly, with meat based pet food from the market in term of torque.

Before analysis, pet food products from the market used in the example i.e. moist pet food (FÉLIX® EMINCÉS EN GELÉE, KITEKAT®, SHEBA® TERRINE CLASSIQUE, WHISKAS® EN GELÉE, FÉLIX® SENSATION, SHEBA® DELICE, GOURMET PERLE, SHEBA® DOME (blanc de poulet)) were put in boiling water until water boils again, removed from boiling water, drained through a sieve and washed with cold water.

In the following table, torque values are given after 30 seconds, 10 minutes and 14 minutes for all the above cited products.

TABLE 3

| | | | Torque at | Torque | Torque | Torque 30 |
|---|---|---|---|---|---|---|
| Pet food | Manufacturing | Name of | 30 sec (in | at 10 min | at 14 min | sec/Torque |
| category | method | product | g*m) | (in g*m) | (in g*m) | 10 min |
| Moist | | SHEBA ® | 5 | 3 | 2 | 1.7 |
| | | Terrine | | | | |
| | | Classique | | | | |
| | | KITEKAT ® | 4 | 4 | 3 | 1.2 |
| | | WHISKAS ® | 6 | 5 | 4 | 1.4 |
| | | en gelée | | | | |
| | | FÉLIX ® en | 12 | 8 | 7 | 1.4 |
| | | gelée | | | | |
| | | SHEBA ® | 10 | 9 | 8 | 1.1 |
| | | Delice | | | | |
| | HMTP | GOURMET ® | 20 | 11 | 10 | 1.9 |
| | | Perle | | | | |
| | | FÉLIX ® | 27 | 14 | 12 | 1.9 |
| | | sensation | | | | |
| | | SHEBA ® | 38 | 18 | 15 | 2.2 |
| | | Dome | | | | |
| | | (blanc de | | | | |
| | | poulet) | | | | |
| Product | | W1 | 18 | 12 | 12 | 1.5 |
| of | | W2 | 14 | 12 | 11 | 1.2 |
| invention | | W3 | 16 | 10 | 10 | 1.5 |

Where comparing the torque observed for the product of embodiments of the invention to the one of the moist category, it can be said that the product of embodiments of the invention which is a meat analogue has a similar and even better texture compared to most of the products from the market which contains meat. The products from the market with a better texture (GOURMET® Perle, FÉLIX® sensation or SHEBA® Dome) are expensive products from the market made with very complex processes and/or with a limited panel of ingredients.

The products of embodiments of the invention keeping a good texture even if lower than some products that are made by high-moisture extrusion cooking. However, these HMTP are expensive.

Moreover, even if having a greater texture, these HMTP have a ratio torque value at 30 sec/torque value at 10 mn out of about 1 to 1.5.

### Example 5

The nutritional content of the meat analogue of an embodiment of the invention was calculated and then compared a moist pet food product of the market (see table 4)

TABLE 4

| Overall | Moisture | Proteins | Fibers | Fat |
|---|---|---|---|---|
| composition | g/100 g | g/100 gDM | g/100 gDM | g/100 gDM |
| Meat analogue of | 65.0 | 64 | 10.9 | 5.7 |
| invention | | | | |
| A3 (calculated) | | | | |
| “Diabetic wet” | 82.5 | 51 | 11.4 | 17 |
| for cat, | | | | |
| Royal Canin | | | | |

DM = dry matter

By comparing the products of embodiments of the invention to one example of the market comprising a mix of proteins, it can be seen that the product of embodiments of the invention has a very low content in lipids but a high content in fibers, proteins and carbohydrates giving to this product a very nice nutritional profile. In particular, the high protein and fiber contents of the meat analogue of embodiments of the invention may be useful to manage weight and diabetes. Indeed, commercial products having such nutritional profile as the one mentioned hereunder are considered as dietetics foods and are specifically dedicated to weight management and diabetic pets.

### Example 6

Vital wheat gluten powder (AMYGLUTEN®)(46 parts), chick pea flour (21 parts), wheat fiber (VITACEL® WF200) (4 parts) and glycerol (100%) (29 parts) are continuously mixed together in a twin screw extruder (Werner & Pfleiderer ZSK25) at a temperature of 65° C., and shaped and cut to obtain small particles with a ZGF30 pelletizer (Werner & Pfleiderer), thereby providing product A4. These particles can then be stored at room temperature, without risk of spoilage.

Agglomerates of these particles are prepared by adding 13 parts of water and 25 parts of hydrated chick pea over the particles in a Meissner bowl cutter (RS 35) and cutting for 1 min (speed 3 for the bowl and speed 2 for the blade). Then, the agglomerates are grinded continuously through a Hobart meat grinder attachment (Hobart A200N, plate of #12 1/8″), thereby providing multiples strands.

The strands are passed continuously through a manual dough sheeter set with a thickness between the steel cylinders of 5 mm, thereby providing a continuous strip of 15 mm thickness and 150 mm width. Pieces of 15 mm×30 mm are cut from this strip.

These pieces are then fried in cooking oil at 150° C. for 5 minutes and hydrated for 48 hours, sterilized in 2 kg bags for 45 min at 125° C. or 500 g bags for 20 min at 125° C. resulting respectively in products W4 and W5 containing both 60-65% water (35-40% dry substance). The products are then analyzed with the Plastograph as described elsewhere.

In the following table, torque values are given after 30 seconds, 10 minutes and 14 minutes for all the above cited products.

TABLE 5

| | Torque at | Torque at | Torque at | Torque 30 |
|---|---|---|---|---|
| Name of | 30 sec | 10 min | 14 min | sec/Torque |
| product | (in g*m) | (in g*m) | (in g*m) | 10 min |
| W4 | 8.1 | 6.7 | 6.5 | 1.3 |
| W5 | 8.2 | 7.4 | 7.0 | 1.2 |

The results of table 5 show that after a sterilization step even strong sterilization, products W4 and W5 keep their texture. Consequently, the product of embodiments of the invention is withstanding sterilization. Comparing to products of the market (see table 3) it can be said that the W4 and W5 samples as previously shown for W1, W2 and W3, have a similar and even a better texture.

1. A food composition comprising at least a first component and a second component in contact with the first component, wherein said first component is substantially water-based and wherein the second component is a solid component comprising a proteinaceous meat analogue,
wherein said proteinaceaous meat analogue comprises:
more than 50% water content
15-25% (w/w) proteins, said proteins comprising vegetable proteins of which more than 60% (w/w) are wheat gluten,
2-5% (w/w) fat,
8-15% (w/w) carbohydrates,
2 to 8% (w/w) fibers, and/or
wherein said proteinaceous meat analogue has a torque value at 10 mn of at least 6 gram meter and/or a ratio torque value at 30 sec/torque value at 10 mn of about 1 to 1.7, as determined by a Test A wherein Test A is implemented by introducing a 70 g cube of an hydrated sample to be tested in a mixing chamber thermo-stated at 37° C. of a Brabender Plastograph, type EC equipped with a type 50 measuring head and a mixing chamber comprising two counter-rotating identical sigma shaped mixing blades, measurement being obtained by counter-rotating the mixing blades at differential speeds of 34 rpm and 22.67 rpm (34*2/3).

2. The food composition according to claim 1 wherein said vegetable proteins comprises vegetable proteins other than wheat gluten in a ratio of vegetable protein other than wheat gluten/wheat gluten of between 1/99 and 60/40.

3. The food composition according to claim 1 wherein said proteinaceous meat analogue has a torque value at 10 mn of between 7 to 20-gram meter and/or wherein said proteinaceous meat analogue has a ratio torque value at 30 sec/torque value at 10 mn of about 1 to 1.5, as determined by Test A

4. The food composition according to claim 1 wherein said carbohydrates comprise less than 4% (w/w) of plasticizer.

5. The food composition according to claim 1 wherein said first component is a liquid, pasty or gelled component.

6. The food composition according to claim 1 wherein said second solid component has a mass of at least 0.03 g.

7. A method for obtaining a food composition comprising at least a first component and a second component in contact with the first component, wherein said first component is a substantially water-based, and wherein the second component is a solid component comprising a proteinaceous meat analogue which comprises:
more than 50% water content-,
15-25% proteins,
2-5% (w/w) fat,
8-15% (w/w) carbohydrates,. among which said plasticizer,
2 to 8% (w/w) fibers,
and, said method comprises a step of:
a) obtaining said proteinaceaous meat analogue by:
mixing at a temperature of less than 100° C. i) vegetable proteins comprising at least vital wheat gluten (VWG) ii) a plasticizer for obtaining a dough, and
heating between 120 to 160° C. during 1 minute to 1 hour of said dough or said agglomerate for obtaining said proteinaceous meat analogue,
b) incorporating said proteinaceous meat analogue or a solid mix comprising said proteinaceous meat analogue in said first component and obtaining said food composition.

8. The method according to claim 7 wherein said proteinaceous meat analogue comprises:
between 60 to 70% water content
15-25% vegetable proteins,
2-5% (w/w) fat,
8-15% (w/w) carbohydrates among which said plasticizer,
2 to 8% (w/w) fibers.

9. The method according to claim 7 wherein the vegetable proteins are a mixture of vital wheat gluten and vegetable proteins from at least one origin selected from a group consisting of potato, lupine, soya, pea, chick pea plants, alfalfa, faba bean, lentil, bean, rapeseed, sunflower and cereals.

10. The method according to claim 7 wherein the mixing step at a temperature of less than 100° C. comprises mixing of 30 to 90% (w/w) of VWG powder, 10 to 40% (w/w) of a plasticizer, 0 to 40% of a vegetable protein other than VWG and 0 to 8% (w/w) of fibers.

11. The method according to claim 7 wherein the mixing step further includes iii) fibers, wherein the fibers are insoluble fibers.

12. The method according to claim 7 wherein obtaining said proteinaceous meat analogue further comprises shaping said dough by cutting the dough into dough pieces and agglomerating said dough pieces and/or at least one inclusion to obtain said agglomerate, wherein the agglomeration is carried out by i) hydrating the dough pieces and/or said at least one inclusion and ii) mixing to obtain an agglomerate, typically having a water content of between 5%-30%.

13. The method according to claim 7 wherein a food product, a food additive and/or a processed food is added during the mixing step.

14. A method of using a food composition according to claim 1, comprising determining a need for improving digestion or improving periodontal health in a companion animal and feeding the companion animal the food composition according to claim 1.

15. The food composition according to claim 1, wherein said proteinaceous meat analogue comprises:
between 60 to 70% water content
17-20% (w/w) proteins,
2-5% (w/w) fat,
10-12% (w/w) carbohydrates,
3 to 6% (w/w) fibers.

16. The food composition according to claim 4, wherein said carbohydrates comprise 1 to 3.5% (w/w) of plasticizer.

17. The method according to claim 7, wherein said plasticizer is selected from a polyhydroxy alcohol, a starch hydrolysate, a carboxylic acid and mixtures thereof, and wherein the mixing step further includes iii) fibers.

18. The method according to claim 17, wherein obtaining said proteinaceous meat analogue further comprises shaping said dough, said method further comprising:
c) incorporating said proteinaceous meat analogue with food particles to obtain a solid mix comprising said proteinaceous meat analogue; and
d) thermally processing said food composition.

19. The method according to claim 12, wherein the obtained agglomerate has a water content of 7%-25%.

20. The method according to claim 19, wherein the obtained agglomerate has a water content of 10%-20%.
